(19) United States
(12) Patent Application Publication
(10) Pub. No.: US 2011/0030490 A1
(43) Pub. Date: Feb. 10, 2011

(54) Lock for a Vehicle Slide-Out Room

(76) Inventor: Borivoj Krobot, La Porte, IN (US)

Correspondence Address: QUARLES & BRADY LLP, 411 E. WISCONSIN AVENUE, SUITE 2040, MILWAUKEE, WI, 53202-4497, US

(21) Appl. No.: 12/851,386

(22) Filed: Aug. 5, 2010

Related U.S. Application Data
(60) Provisional application No. 61/231,909, filed on Aug. 6, 2009.

(51) Int. Cl. F16H 57/00

(52) U.S. Cl. 74/411.5

(57) ABSTRACT

A lock for a vehicle slide-out room disclosed. The lock comprises a frame connected to the slide-out room and a drive unit supported by the frame. The lock further comprises a transmission driven by the drive unit. The transmission includes a segment gear pivotally supported by the frame and having a peripheral edge including a plurality of gear teeth. The lock further comprises a lock arm pivotally supported by the frame and driven by the drive unit through the transmission. The lock arm is driven so as to pivot from an extended position to a retracted position and vice versa. In the extended position, the lock arm engages a side wall of the vehicle to prevent the slide-out room from extending relative to the side wall of vehicle. In the retracted position, the lock arm disengages the side wall of the vehicle.

### CROSS-REFERENCE TO RELATED APPLICATION

This claims the benefit of U.S. Provisional Patent Application No. 61/231,909 filed Aug. 6, 2009, the disclosure of which is hereby incorporated for all purposes.

### STATEMENT CONCERNING FEDERALLY SPONSORED RESEARCH OR DEVELOPMENT

Not applicable.

### FIELD OF THE INVENTION

This invention relates to locks, particularly locks for slide-out rooms of recreational vehicles.

### BACKGROUND OF THE INVENTION

Many types of recreational vehicles include one or more slide-out rooms to increase the size of the vehicle living quarters while also permitting an appropriate size for highway travel. Each slide-out room is moved by a number of actuators such as hydraulic cylinders, electric drive screws or electric gear drives located on the recreational vehicle. In some designs, a controller is used to ensure synchronized movement of the actuators. In addition, slide-out rooms also typically include a lock that ensures seals on the slide-out room are adequately compressed against a wall of the vehicle in the retracted position to prevent air drafts from entering the living quarters.

Most slide-out room locks include a drive unit, such as a power screw connected to a push rod, that drives a pivotable lock arm to engage a side wall of the vehicle. In addition, these components are supported within a frame that extends into the living quarters provided by the slide-out room. Some individuals do not consider such designs to be aesthetically appealing. However, it is difficult to provide a slide-out room lock that is disposed completely within the slide-out end wall due to the large size of the drive unit and the bulky frame required to support the high loads provided by the drive unit.

Further still, slide-out room locks are typically controlled in an open loop manner; that is, the control system for the slide-out room does not determine if the lock is disengaged before moving the slide-out room. As such, components of the vehicle may be damaged if the slide-out room moves when the lock is engaged.

Considering the drawbacks of previous slide-out room locks, an improved design is needed in which the lock occupies less space within the vehicle living quarters and preferably is controllable in a closed-loop manner.

### SUMMARY OF THE INVENTION

In one aspect, the present invention provides a lock for a vehicle having a slide-out room that is extendable relative to a side wall of the vehicle. The lock comprises a frame connected to the slide-out room and a drive unit supported by the frame. The lock further comprises a transmission driven by the drive unit. The transmission includes a segment gear pivotally supported by the frame and having a peripheral edge including a plurality of gear teeth. The lock further comprises a lock arm pivotally supported by the frame and driven by the drive unit through the transmission. The lock arm is driven so as to pivot from an extended position to a retracted position and vice versa. In the extended position, the lock arm engages the side wall of the vehicle to prevent the slide-out room from extending relative to the side wall of vehicle. In the retracted position, the lock arm disengages the side wall of the vehicle.

In another aspect, the lock comprises a frame connected to the slide-out room and a drive unit supported by the frame. The lock further comprises a transmission driven by the drive unit. The transmission includes a segment gear pivotally supported by the frame. The segment gear has a peripheral edge including a plurality of gear teeth and a foot. The transmission further includes at least a first follower link having a first end pivotally connected to the segment gear and a second end opposite the first end. The lock further comprises a lock arm pivotally supported by the frame and pivotally connected to the second end of the first follower link so as to be driven by the drive unit through the transmission. The lock arm is driven so as to pivot from an extended position to a retracted position and vice versa. In the extended position, the lock arm engages the side wall of the vehicle to prevent the slide-out room from extending relative to the side wall of the vehicle. In the retracted position, the lock arm disengages the side wall of the vehicle and engages the foot of the segment gear. The lock further comprises a sensor unit that is operable to determine if the lock arm is in the retracted position or another position.

The foregoing and other advantages of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a perspective view of a vehicle slide-out room in an extended position and incorporating a room lock of the present invention;

FIG. 2 is a perspective view of the vehicle slide-out room of FIG. 1 in a retracted position;

FIG. 3 is a perspective view of the vehicle slide-out room of FIG. 1 in the retracted position and the room lock moving towards an extended position in which the room lock prevents the slide-out room from extending;

FIG. 4 is a perspective view of the vehicle slide-out room of FIG. 1 in the retracted position and the room lock in the extended position;

FIG. 5 is a perspective view of the room lock of the present invention in a retracted position;

FIG. 6 is a perspective view of the room lock from the opposite angle of FIG. 5;

FIG. 7 is a partial section side view of the room lock of FIG. 5 in the retracted position;

FIG. 8 is a partially exploded perspective view of the room lock of FIG. 5;

FIG. 9 is a perspective view of the room lock of FIG. 5 in the extended position;

FIG. 10 is a perspective view of the room lock from the opposite angle of FIG. 9;

FIG. 11 is a side view of the room lock of FIG. 5 in the extended position;

FIG. 12 is a top view of the room lock of FIG. 5 in the extended position;

FIG. 13 is another partially exploded perspective view of the room lock of FIG. 5;

FIG. 14 is a top view of a transmission assembly and a lock arm of the room lock of FIG. 5;

FIG. 15 is a perspective view of the transmission assembly and the lock arm of FIG. 14;

FIG. 16 is an exploded perspective view of the transmission assembly and the lock arm of FIG. 14;

FIG. 17 is a perspective view of an inner frame of the room lock in the retracted position;

FIG. 18 is a perspective view of the inner frame of FIG. 17 in the extended position;

FIG. 19 is a rear view of the inner frame of FIG. 17 in the extended position;

FIG. 20 is a section view along line 20-20 of FIG. 19;

FIG. 21 is a top view of the room lock of FIG. 5 in the retracted position and with an upper frame bracket removed for clarity;

FIG. 22 is a top view of the room lock of FIG. 5 moving towards the extended position and with the upper frame bracket removed for clarity; and

FIG. 23 is a top view of the room lock of FIG. 5 in the extended position and with the upper frame bracket removed for clarity.

### DETAILED DESCRIPTION OF THE INVENTION

The particulars shown herein are by way of example and only for purposes of illustrative discussion of the embodiments of the invention. The particulars shown herein are presented to provide what is believed to be the most useful and readily understood description of the principles and conceptual aspects of the invention. In this regard, no attempt is made to show structural details of the invention in more detail than is necessary for the fundamental understanding of the invention. The description taken with the drawings should make apparent to those skilled in the art how the several forms of the present invention may be embodied in practice.

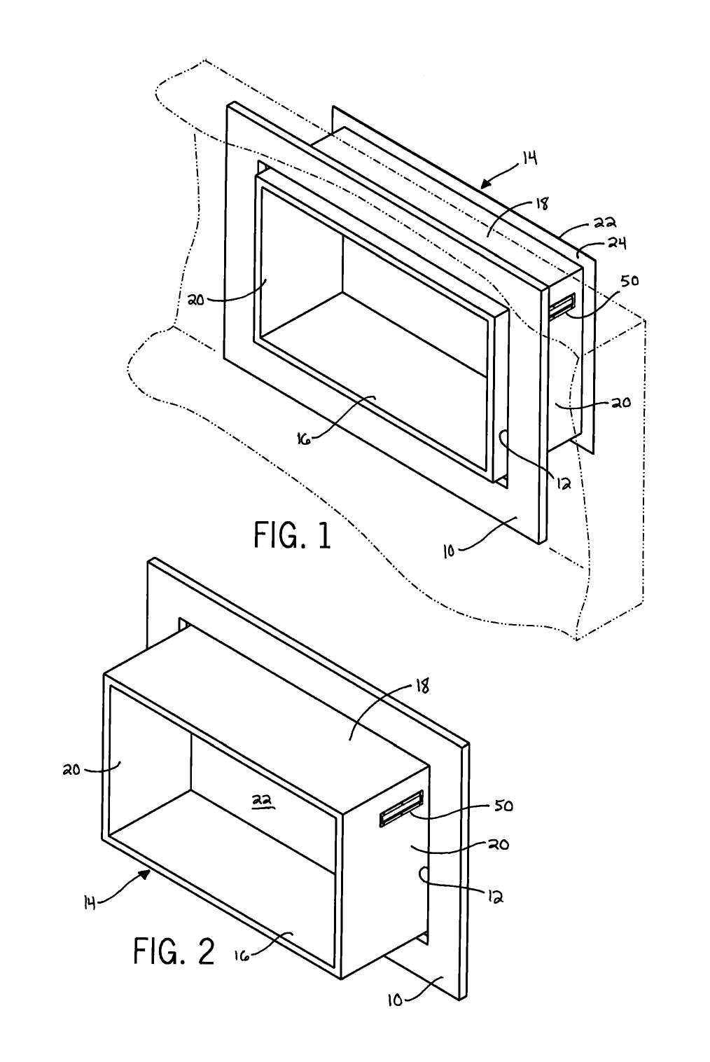

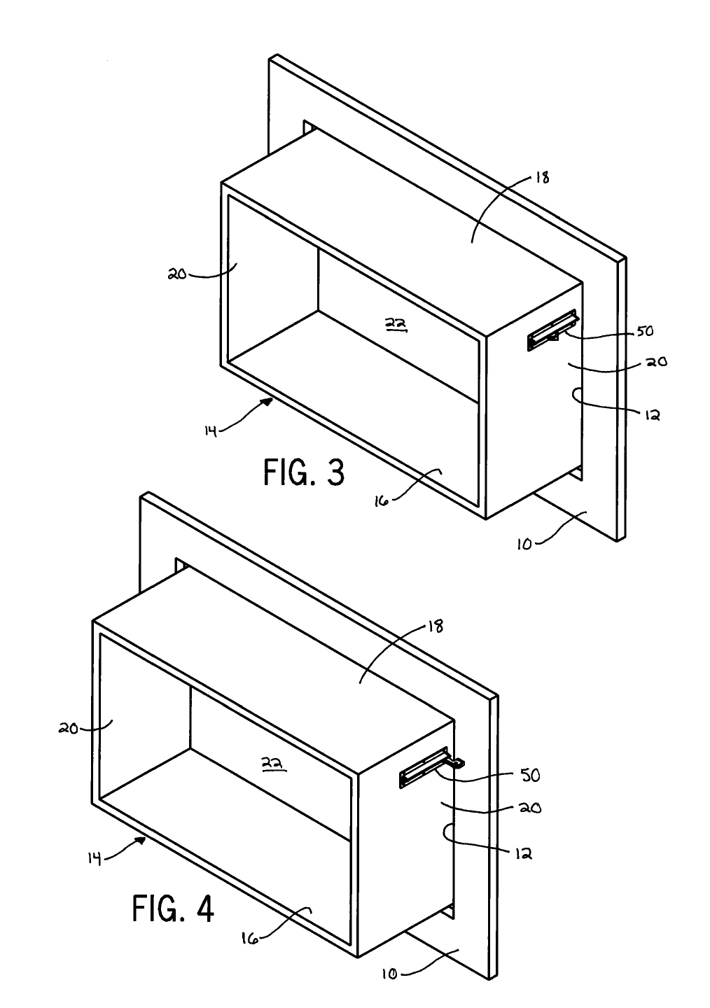

Referring to FIGS. 1-4, a recreational vehicle incorporating one or more slide-out room locks 50 of the present invention includes a side wall 10 defining a wall opening 12. The wall opening 12 accommodates a slide-out room 14 that is extendable (FIG. 1) and retractable (FIGS. 2-4) relative to the side wall 10. The slide-out room 14 includes a floor 16, a ceiling 18, and end walls 20 supporting an outer wall 22. The outer wall 22 includes a fascia surface 24 (FIG. 1) extending outwardly from the floor 16, the ceiling 18, and the walls 20 and facing the side wall 10 of the vehicle. The fascia surface 24 may include a seal (not shown) that is compressible between the outer wall 22 and the vehicle side wall 10 in the retracted position. Appropriate seal designs will be recognized by those skilled in the art. The fascia surface 24 may also connect to one or more room slides (not shown) that extend and retract the slide-out room 14. Alternatively, the room slides may connect to the bottom of the slide-out room floor 16. In any case, appropriate room slide designs will be recognized by those skilled in the art.

One or both of the slide-out room end walls 20 each house a room lock 50 of the present invention. When the slide-out room 14 is retracted, the room locks 50 occupy an extended position (FIG. 4) and engage the vehicle side wall 10 to prevent the slide-out room 14 from extending. Furthermore, the room locks 50 move to a retracted position (FIG. 2) to disengage the side wall 10 before the room slides extend the slide-out room 14.

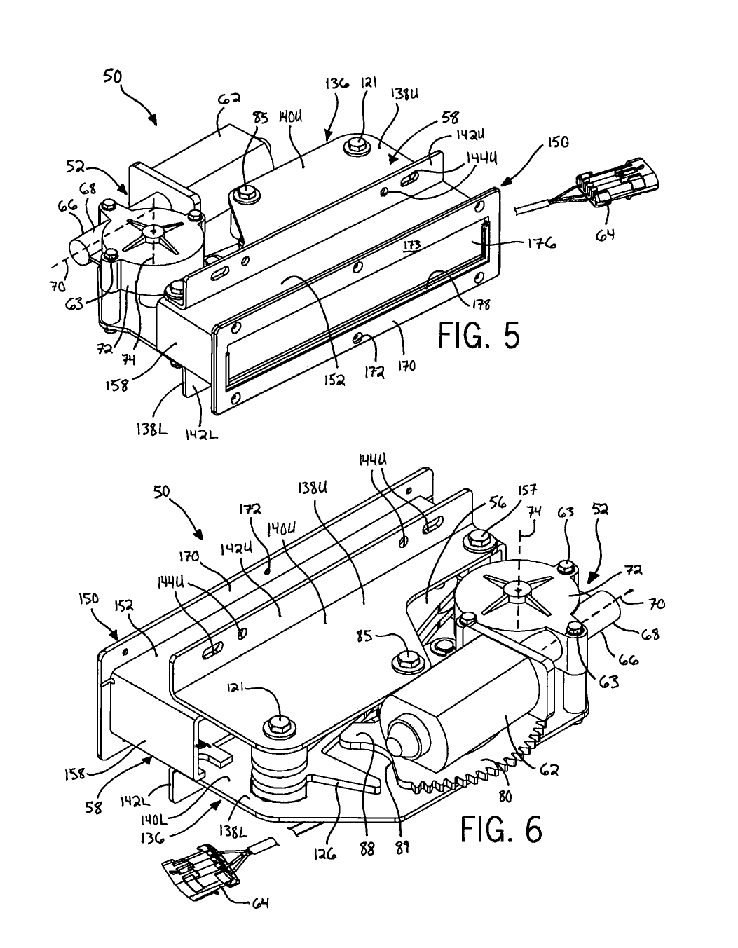

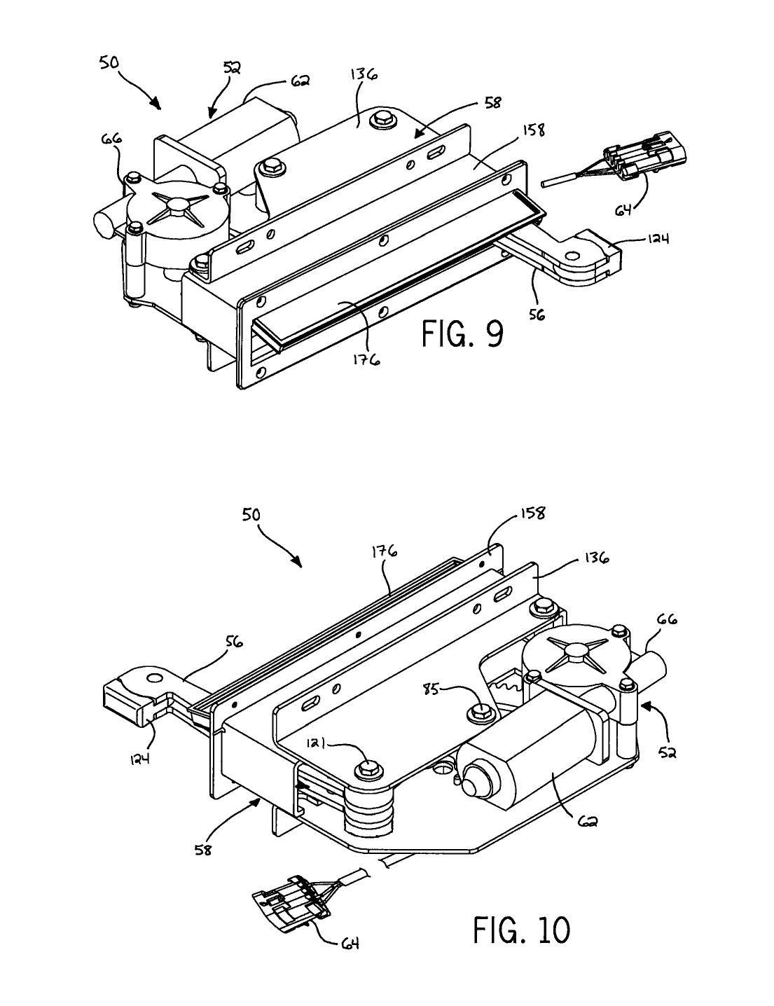

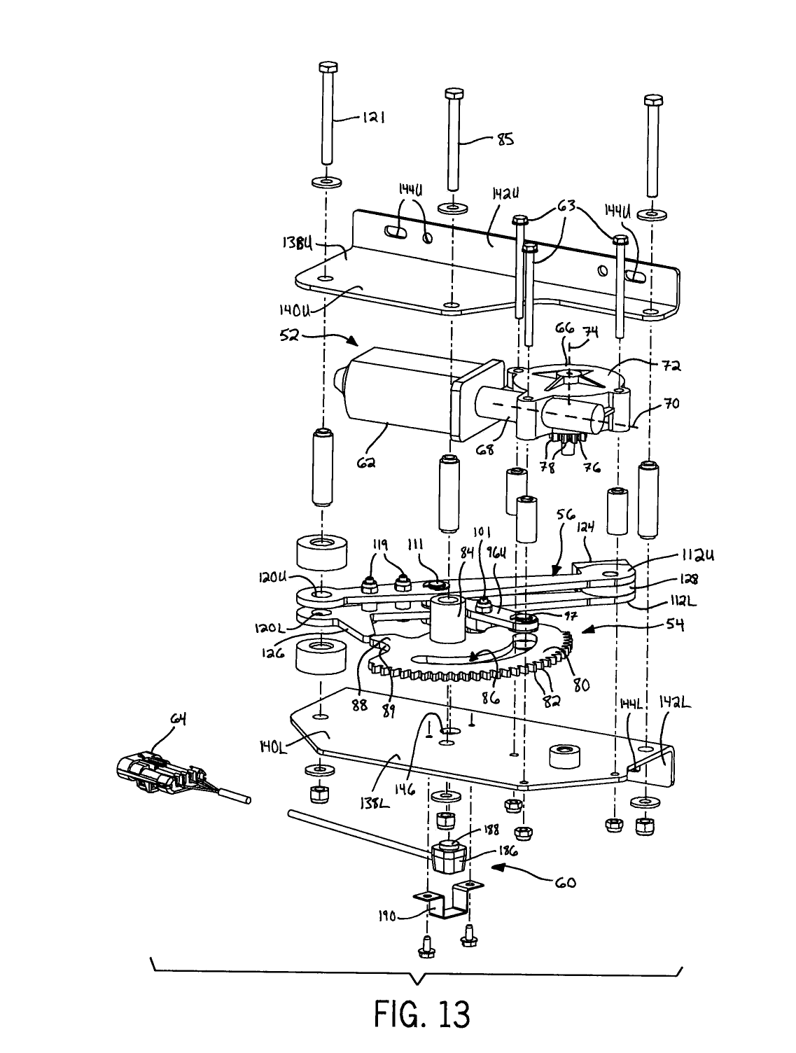

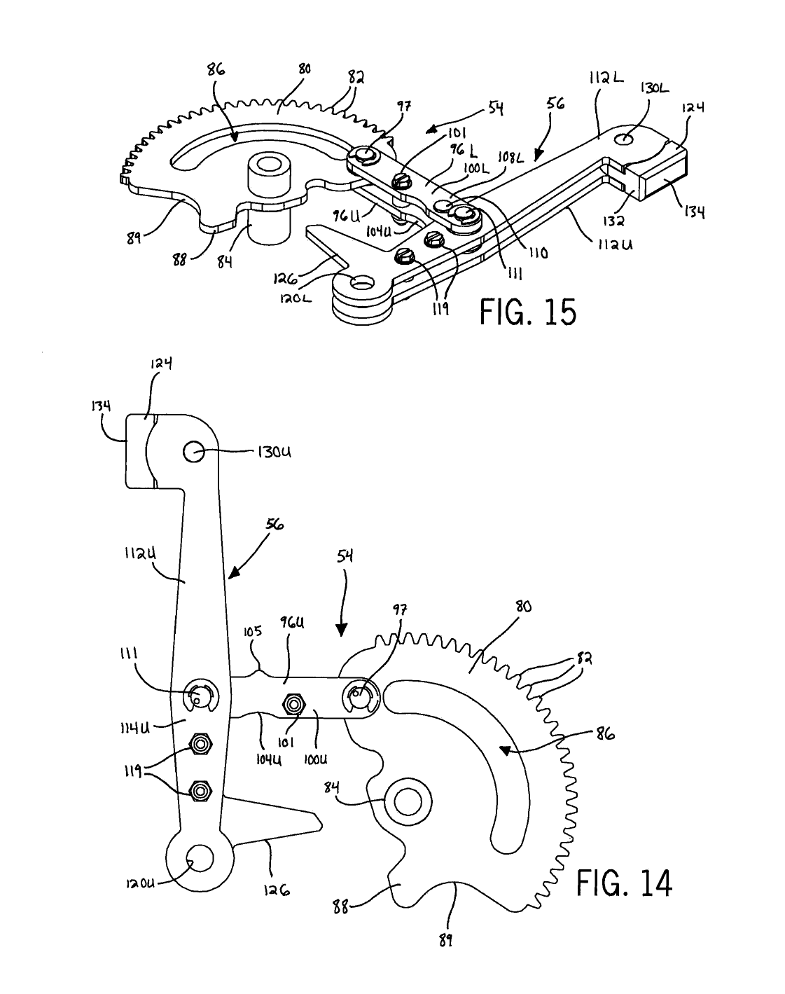

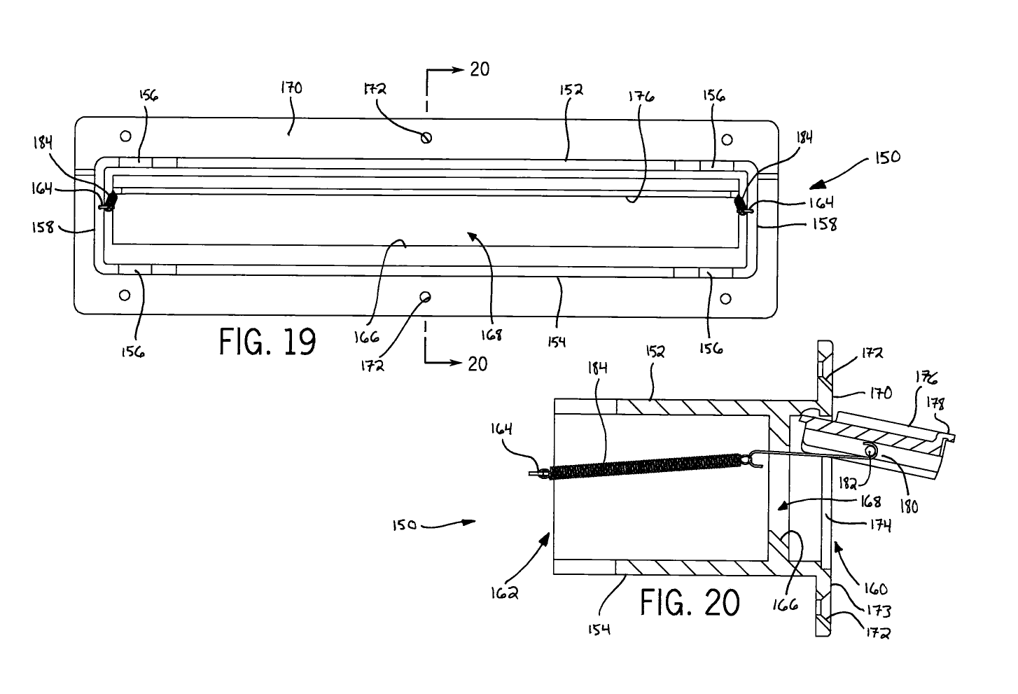

Referring now to FIGS. 5-23, the room lock 50 is a relatively flat assembly that preferably has larger dimensions in length and width directions (horizontal directions when the slide-out room 14 is level) than a height direction (a vertical direction when the slide-out room 14 is level). The room lock 50 includes a drive unit 52 connected to a transmission 54 (FIGS. 13-16) to move a lock arm 56 between the retracted position (FIGS. 5-7) and the extended position (FIGS. 9-12) in which the lock 50 prevents the slide-out room 14 from extending. The room lock 50 further includes a frame 58 that supports the drive unit 52 and the transmission 54 and connects to the slide-out room end wall 20. The frame 58 also supports a sensor unit 60 that senses the position of the transmission 54 and the lock arm 56 (i.e., if the lock arm 56 is retracted). These components are described in further detail below, beginning with the drive unit 52 and concluding with the sensor unit 60.

Referring to FIGS. 5-8 and 13, the drive unit 52 includes a drive motor 62 that may be, for example, an electric DC motor or the like. The drive motor 62 preferably includes flat sides and is positioned horizontally (i.e., in the width direction of the lock 50 or horizontally when the frame 58 is disposed horizontally) to reduce the overall height of the lock 50. The drive motor 62 may be connected to a power source via electrical leads (not shown) or through a connector 64 of the sensor unit 60.

The drive motor 62 drives a worm gear transmission 66 connected to the frame 58 by threaded fastener/spacer assemblies 63 or the like. As the name implies, the worm gear transmission 66 includes a worm (not shown) driven by the drive motor 62 and driving a worm gear (not shown). The worm gear transmission 66 further includes an elongated worm frame 68 supporting the worm and defining a worm axis 70 about which the worm rotates. The worm frame 68 is preferably disposed horizontally to reduce the overall height of the lock 50. The worm frame 68 connects to a worm gear frame 72 supporting the worm gear and defining a worm gear axis 74 about which the worm gear rotates. The worm gear axis 74 is perpendicular to the worm axis 70. The worm gear fixedly connects to an output gear 76 (FIG. 13) disposed below the worm gear frame 72 and including a plurality of gear teeth 78. The output gear 76 drives the transmission 54 as described in further detail below.

As those skilled in the art will appreciate, the worm gear transmission 66 is, by design, extremely difficult to back-drive, for example, by manually applying a load to move the lock arm 56 towards the retracted position. As such, the slide-out room 14 cannot be easily extended without first moving the lock arm 56 to the retracted position by powering the drive motor 62.

Referring now to FIGS. 13-16 and 21-23, the transmission 54 includes a segment gear 80 that is generally disposed horizontally to reduce the overall height of the lock 50. However, the segment gear 80 is also disposed generally below the drive motor 62 in the retracted position to limit the length and width of the frame 58 and, therefore, the space required to mount the lock 50 in the slide-out room 14. The segment gear 80 has a peripheral edge including plurality of gear teeth 82 engaging and driven by the output gear teeth 78. The gear teeth 82 extend, for example, about a 135 degree arc or less so that the segment gear 80 avoids contact with other components. The segment gear 80 also includes a central support tube 84 pivotally accommodating, for example, a threaded fastener/spacer assembly 85 connected to the frame 58. An arcuate opening 86 disposed radially outwardly from the support tube 84 permits one of the fastener assemblies 63 connecting the worm gear transmission 66 and the frame 58 to pass there through.

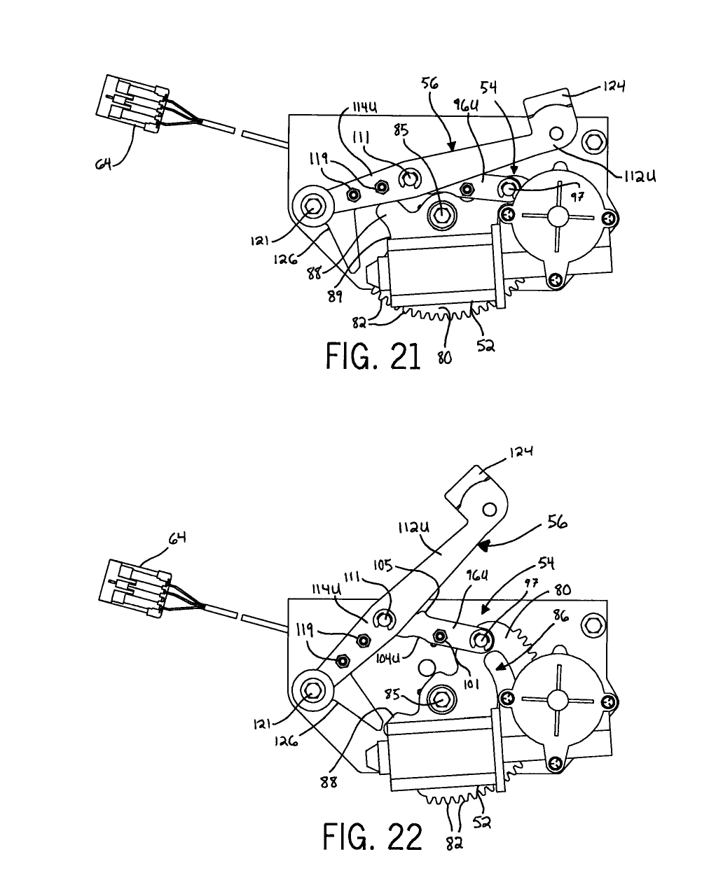

A first end of the segment gear 80 at a first side of the support tube 84 includes a foot 88 for engaging the lock arm 56 in the retracted position (FIG. 21). That is, the foot 88 acts as a hard stop when pivoting the lock arm 56 to the retracted position. Such contact quickly increases the current drawn by the drive motor 62 as the lock arm 56 enters the retracted position. As such, a controller (not shown) or a current sensor (not shown) may be operatively connected to the drive motor 62 to de-energize the motor 62 after sudden current increases.

The foot 88 is disposed adjacent a curved wall 89 of the first end of the segment gear 80. As most easily appreciated from FIGS. 21-23, the curved wall 89 permits the segment gear 80 to avoid contact with the lock arm 56 as the transmission 54 drives the lock arm 56 from the retracted position to the extended position.

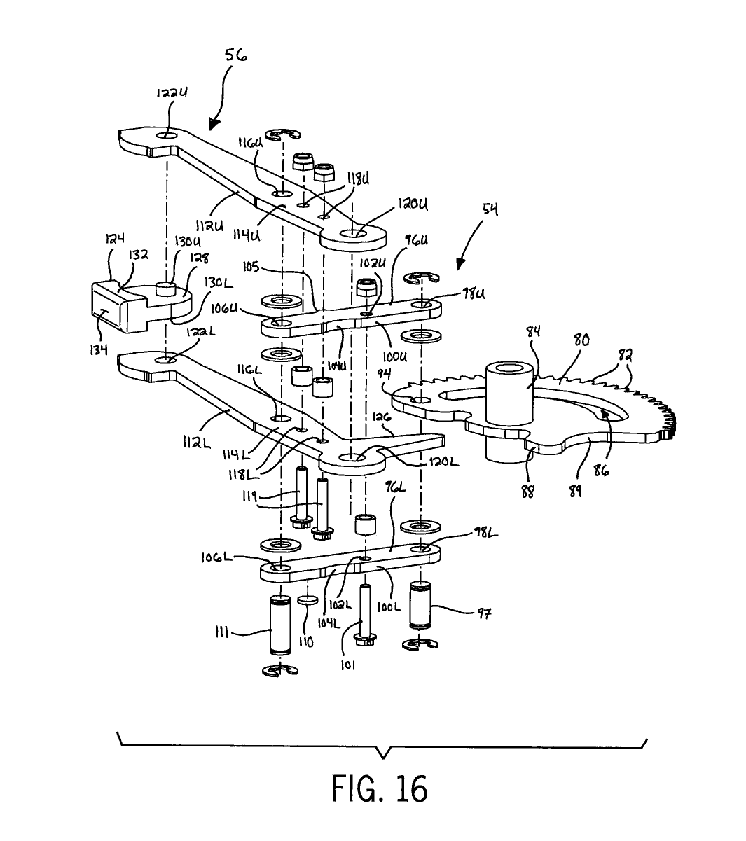

Referring again to FIGS. 13-16 and 21-23 and specifically FIG. 16, a second end opening 94 of the segment gear 80 opposite the foot 88 drivingly connects an upper follower link 96U and a lower follower link 96L, for example, via a single pivot pin/spacer assembly 97. As the names imply, the upper follower link 96U and the lower follower link 96L are disposed above and below the segment gear 80, respectively. The upper follower link 96U is a generally elongated component that preferably pivots in a horizontal plane. A first end opening 98U of the upper follower link 96U pivotally connects to the segment gear 80 via the pivot pin assembly 97. An intermediate section 100U adjacent the first end opening 98U has an opening 102U accommodating, for example, a fastener assembly 101 fixedly connecting the upper and lower follower links 96U and 96L. The intermediate section 100U also includes an arcuate notch 104U disposed adjacent the opening 102U permitting the upper follower link 96U to avoid contact with the segment gear support tube 84. A finger or tab 105 distinguishing the upper follower link 96U from the lower follower link 96L is disposed opposite the notch 104U. Such a feature may be useful during manufacturing of the room lock 50. The intermediate section 100U also separates a second end opening 106U of the upper follower link 96U from the first end opening 98U.

The lower follower link 96L is preferably generally identical to the upper follower link 96U. That is, the lower follower link 96L includes a first end opening 98L and a second end opening 106L separated by an intermediate section 100L. The intermediate section 100L has an opening 102L accommodating the fastener assembly 101 and an arcuate notch 104L for avoiding contact with the segment gear support tube 84. However, unlike the upper follower link 96U, the lower surface 108L (FIG. 15) of the lower follower link 96L includes a recess (not shown) housing a magnet 110. The magnet 110 is sensed by the sensor unit 60 to indicate whether the lock arm 56 is in the retracted position or another position as described in further detail below. Furthermore and also unlike the upper follower link 96U, the lower follower link 96L does not include a finger or tab opposite the notch 104L.

Still referring to FIGS. 13-16 and 21-23 and specifically FIG. 16, the second end openings 106U and 106L of the follower links 96U and 96L drivingly connect to the lock arm 56, for example, via a single pivot pin/spacer assembly 111. The lock arm 56 includes an upper lock arm bracket 112U and a lower lock arm bracket 112L. The upper lock arm bracket 112U is a generally elongated L-shape component that preferably pivots in a horizontal plane. An intermediate section 114U of the upper lock arm bracket 112U includes a pivot opening 116U accommodating the pivot pin assembly 111 for pivotally connecting to the follower links 96U and 96L. The intermediate section 114U also includes one or more fastener openings 118U accommodating, for example, fastener assemblies 119 fixedly connecting the upper and lower lock arm brackets 112U and 112L. A first end of the upper lock arm bracket 112U adjacent the intermediate section 114U includes a first end opening 120U pivotally engaging, for example, a threaded fastener/spacer assembly 121 connected to the frame 58. That is, the upper lock arm bracket 112U pivots about the first end opening 120U to move between the extended and retracted positions. The upper lock arm bracket 112U further includes a second end opposite the first end extending away from the elongated intermediate section 114U (i.e., providing the L-shape of the upper lock arm bracket 112U). The second end includes an arm stopper opening 122U connecting to an arm stopper 124 as described in further detail below.

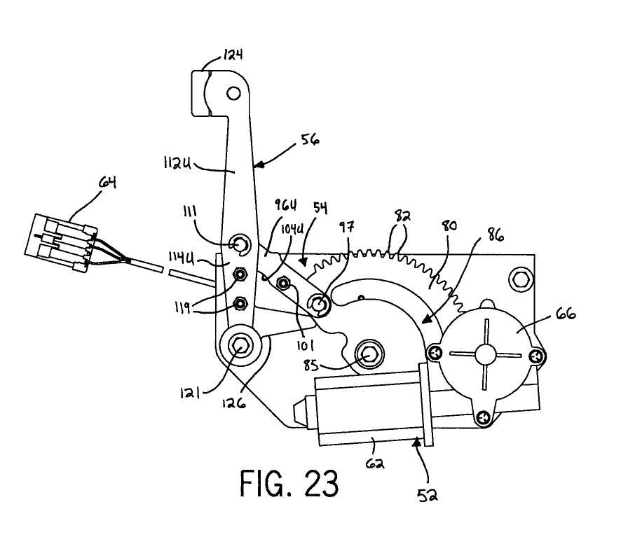

The lower lock arm bracket 112L is preferably generally identical to the upper lock arm bracket 112U. That is, the lower lock arm bracket 112L includes a first end opening 120L and an arm stopper opening 122L disposed on opposite sides of an intermediate section 114L. In addition, the intermediate section 114L includes a pivot opening 116L and one or more fastener openings 118L as described above. However, unlike the upper lock arm bracket 112U, the lower lock arm bracket 112L also includes a leg 126 extending perpendicularly from the intermediate section 114L proximate the first end opening 120L. As shown most clearly in FIG. 23, the leg 126 engages the second end of the segment gear 80 proximate the pivot pin/spacer assembly 97 in the extended position. That is, the leg 126 acts as a hard stop when pivoting the lock arm 56 to the extended position. As described above, such contact quickly increases the current drawn by the drive motor 62 and the drive motor 62 may be de-energized immediately thereafter by a controller or the like.

Still referring to FIGS. 13-16 and specifically FIG. 16, the lock arm 56 further includes an arm stopper 124 disposed between the second ends of the lock arm brackets 112U and 112L. The arm stopper 124 includes a tongue 128 having an upper protrusion 130U and a lower protrusion 130L disposed within the arm stopper openings 122U and 122L, respectively. The tongue 128 supports a stopper block 132 having a leading surface 134 that engages the vehicle side wall 10 in the extended position.

The lock arm 56, the follower links 96U and 96L, the segment gear 80, and part of the frame 58 advantageously define a compact four-bar linkage structure. The sizes and pivot locations of these components are preferably selected so that the lock arm 56 pivots about 80 degrees when the segment gear 80 pivots about 135 degrees. Furthermore, the four-bar linkage structure includes two links having separate hard stops for the extended and retracted positions (i.e., the lower lock arm bracket leg 126 and the segment gear foot 88). Such movable hard stops advantageously eliminate the need for stationary hard stops that could interfere with multiple moving components (e.g., the components of the four-bar linkage structure) of the compact room lock design.

Referring now to FIGS. 5-8, 13, and 17-20, the frame 58 includes an outer frame 136 having an upper frame bracket 138U disposed above a lower frame bracket 138L. The upper frame bracket 138U includes a generally horizontal mounting plate 140U having openings to connect to the fastener assemblies 85 and 121 pivotally supporting the segment gear 80 and the lock arm 56, respectively. The mounting plate 140U is preferably disposed in a plane parallel to the worm axis 70 to further facilitate a compact lock design. The mounting plate 140U connects to a mounting flange 142U extending generally vertically there above. The mounting flange 142U includes a plurality of mounting openings 144U accommodating fasteners (not shown) for connecting the upper frame bracket 138U to the interior surface of the slide-out room end wall 20.

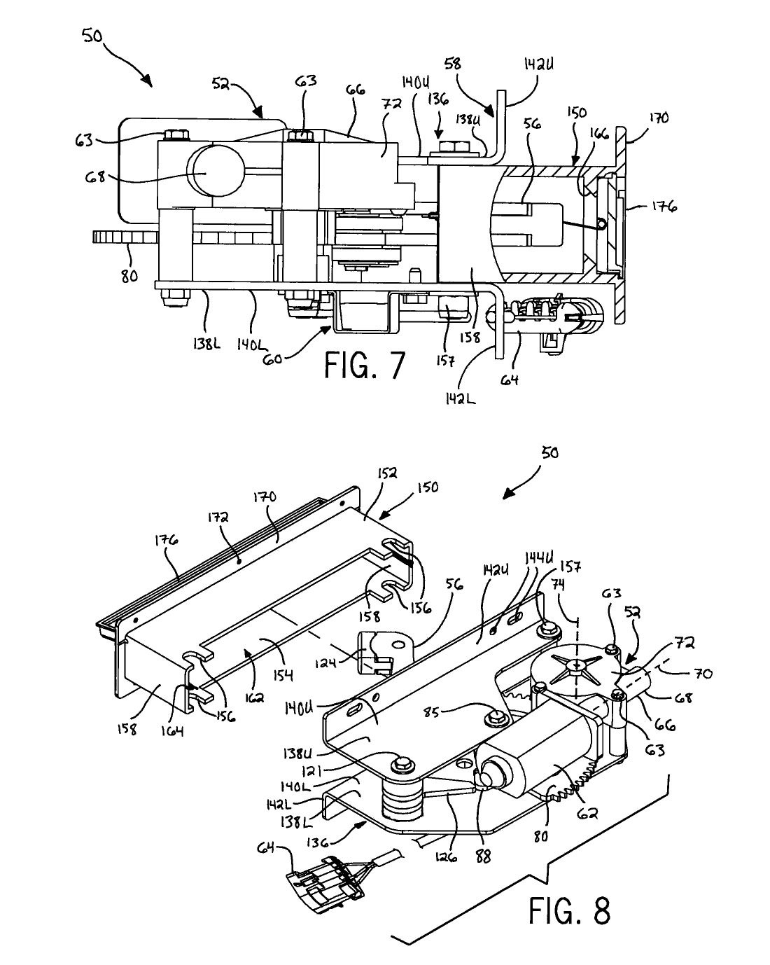

The lower frame bracket 138L includes a generally horizontal mounting plate 140L having openings to connect to the fastener assemblies 85 and 121 pivotally supporting the segment gear 80 and the lock arm 56, respectively, and the fastener assemblies 63 connecting to the worm gear transmission 66. In addition, the mounting plate 140L includes a sensor opening 146 (FIG. 7) accommodating the sensor unit 60 as described in further detail below. The mounting plate 140L extends rearwardly relative to the upper mounting plate 140U to support the drive unit 52; that is, as shown in FIG. 7, the drive unit 52 is disposed horizontally adjacently to the upper frame bracket 138U. Furthermore, the mounting plate 140L is preferably disposed in a plane parallel to the worm axis 70 to further facilitate a compact lock design. The mounting plate 140L connects to a mounting flange 142L extending generally vertically there below. The mounting flange 142L includes one or more mounting openings 144L (FIG. 13) for accommodating fasteners (not shown) connecting the lower frame bracket 138L to the interior surface of the slide-out room end wall 20.

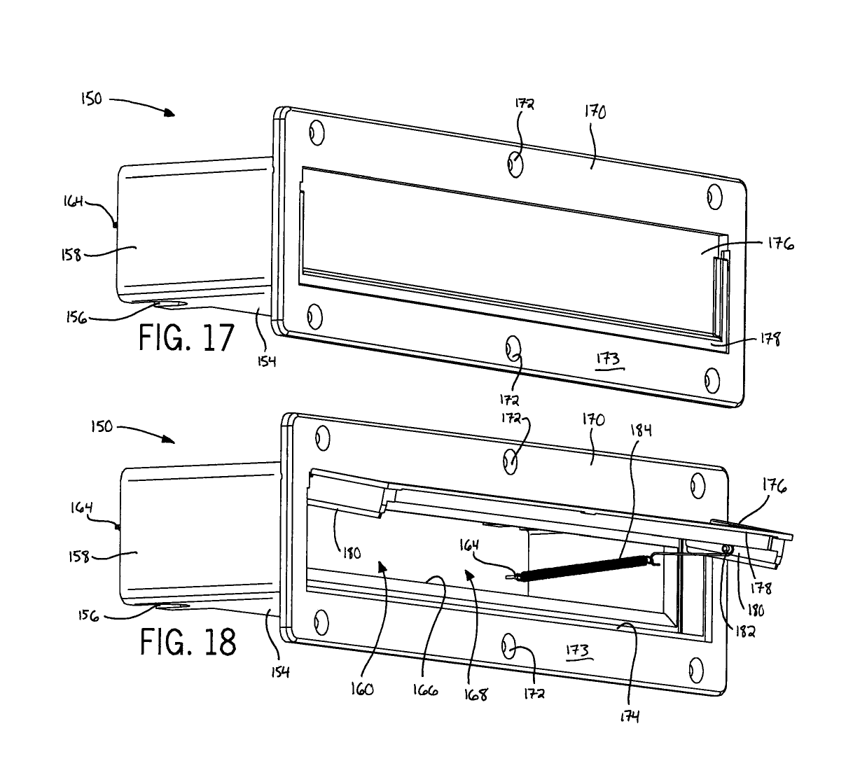

The upper and lower frame brackets 138U and 138L connect to an inner frame 150 shown separately in FIGS. 17-20. The inner frame 150 includes an upper wall 152 and a lower wall 154 both having fastener openings 156 as most clearly shown in FIG. 8. As shown in the figures, only one set of fastener openings 156 accommodates a fastener assembly 157 connecting the inner frame 150 to the outer frame 136. The upper wall 152 and the lower wall 154 connect to side walls 158. Together, the walls 152, 154, and 158 define a first open side 160 (FIG. 20) and a second open side 162 on opposite sides of the inner frame 150. The first and second open sides 160 and 162 define a passageway through which the lock arm 56 extends in the extended position. Each of the side walls 158 also supports a spring attachment post 164 disposed outside the second open side 162 as described in further detail below.

The inner frame 150 also includes a door stop rim 166 extending inwardly from the walls 152, 154, and 158 and disposed between the first and second open sides 160 and 162. The door stop rim 166 also defines a rim opening 168 through which the lock arm 56 extends in the extended position. The inner frame 150 further includes a support flange 170 surrounding the first open side 160 and extending outwardly from the walls 152, 154, and 158. The support flange 170 has a plurality of mounting openings 172 for accommodating fasteners (not shown) connecting the inner frame 150 to the exterior surface of the slide-out room end wall 20. The support flange 170 also includes a front surface 173 facing away from the slide-out room 14 and a stop shoulder 174 recessed from the front surface 173.

A door 176 connects to the side walls 158 of the inner frame 150 and pivots about a generally horizontal axis. The door 176 is pivotable to an open position (FIGS. 18-20) in which the lock arm 56 extends through the inner frame 150 and supports the door 176 there above. The door 176 is also pivotable to a closed position (FIG. 17) in which the lock arm 56 is retracted and the door 176 abuts the door stop rim 166 to close the passageway between the first and second open sides 160 and 162 of the inner frame 150. The door 176 is preferably flushly aligned or slightly recessed from the support flange 170 in the closed position (see FIG. 7) to avoid contact with the vehicle side wall 10 as the slide-out room 14 extends and retracts. Furthermore, a lip 178 disposed at an edge of the door 176 abuts the support flange stop shoulder 174 in the closed position. The door 176 also includes interior side edges 180 each having a spring attachment post 182 connected to an extension spring 184. Each extension spring 184 also connects to the spring attachment post 164 of one of the side walls 158. As such, the extension springs 184 bias the door 176 towards the closed position.

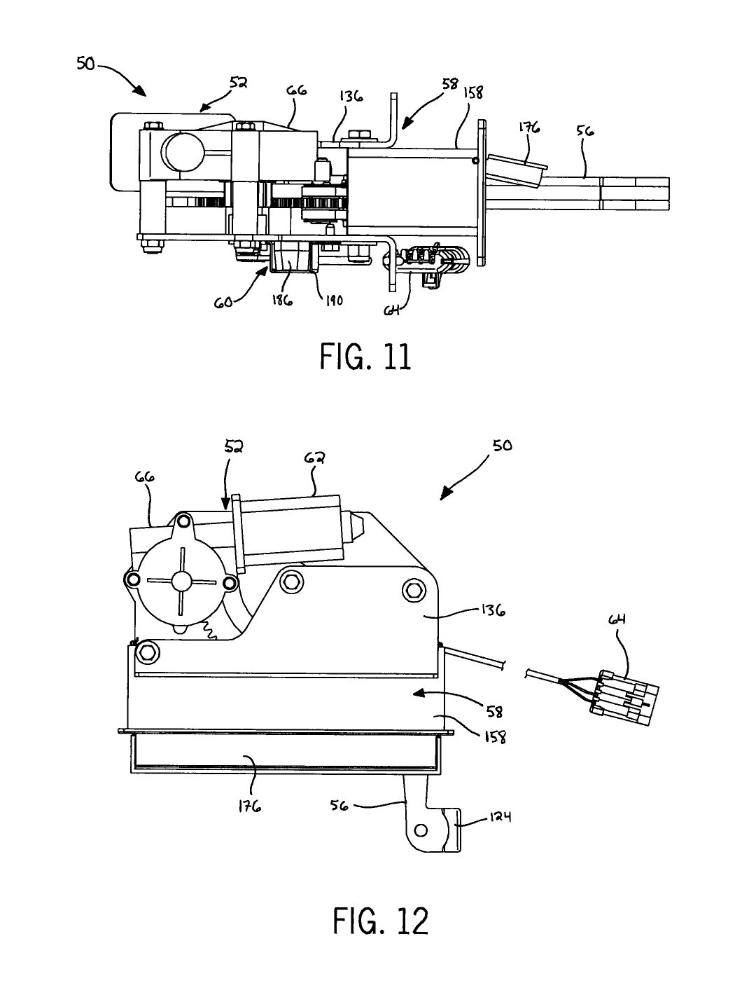

Referring now to FIGS. 11 and 13, the sensor unit 60 includes a hall effect sensor 186 having a sensor element 188 disposed in the lower frame bracket sensor opening 146. The sensor element 188 senses the presence of the magnet 110 connected to the lower follower link 96L when the magnet 110 is disposed directly above the sensor element 188 (i.e., in the retracted position). As such, the hall effect sensor 186 sends a signal indicating whether the lock arm 56 is in the retracted position or another position. Such a signal may be sent to a controller that supplies power to the room lock 50 or a separate controller (not shown) via the connector 64. The hall effect sensor 186 is supported by a sensor bracket 190 connected to the bottom surface of the lower frame bracket 138L, for example, by threaded fasteners or the like.

In some embodiments, the frame 58 may include an additional cover (not shown) to conceal the room lock 50 if the lock 50 is positioned within the interior of the slide-out room 14. In these embodiments, the lock 50 is preferably connected to the slide-out room end wall 20 and disposed just below ceiling 18 so that little valuable space is occupied within the slide-out room 14. As an alternative, the room lock 50 may be connected to the slide-out room end wall 20 and completely concealed within the ceiling 18.

The room lock 50 of the present invention is preferably made from materials and manufacturing processes known to those skilled in the art. For example, the segment gear 80, the follower links 96U and 96L, the lock arm brackets 112U and 112L, and the frame brackets 138U, 138L, and 150 may be steel components manufactured using processes such as hobbing (for the segment gear 80), stamping (for the links 96U and 96L and brackets 112U, 112L, 138U, and 138L), and bending (for the frame brackets 138U and 138L). In addition, contact surfaces between pivoting components (e.g., the segment gear 80 and the follower links 96U and 96L) are preferably lubricated using a lubricant known to those skilled in the art.

The room lock 50 of the present invention advantageously has a compact design provided by the segment gear 80, the movable hard stops (i.e., the foot 88 and the leg 126) of the four-bar linkage structure, the orientation of the drive unit 52, and other features. In addition, the room lock 50 also includes a sensor unit 60 that provides closed-loop feedback regarding the position of the lock arm 56.

A preferred embodiment of the invention has been described in considerable detail. Many modifications and variations to the preferred embodiment described will be apparent to a person of ordinary skill in the art. Therefore, the invention should not be limited to the embodiment described.

I claim:

1. A lock for a vehicle having a slide-out room being extendable relative to a side wall of the vehicle, the lock comprising:
a frame connected to the slide-out room;
a drive unit supported by the frame;
a transmission driven by the drive unit, the transmission including a segment gear pivotally supported by the frame and having a peripheral edge including a plurality of gear teeth; and
a lock arm pivotally supported by the frame and driven by the drive unit through the transmission, the lock arm being driven so as to pivot from an extended position to a retracted position and vice versa, in the extended position the lock arm engaging the side wall of the vehicle to prevent the slide-out room from extending relative to the side wall of vehicle, and in the retracted position the lock arm disengaging the side wall of the vehicle.

2. The lock as in claim 1, wherein the lock arm is disposed within the frame in the retracted position.

3. The lock as in claim 1, wherein the transmission further includes at least a first follower link having a first end pivotally connected to the segment gear and a second end pivotally connected to the lock arm.

4. The lock as in claim 3, wherein the segment gear is pivotally supported by the frame at a first position and lock arm is pivotally supported by the frame at a second position spaced apart from the first position so that the segment gear, the lock arm, the first follower link, and the frame define a four-bar linkage mechanism.

5. The lock as in claim 4, wherein a first of the segment gear, the lock arm, and the first follower link includes a first hard stop engaging a second of the segment gear, the lock arm, and the first follower link in the retracted position, and the second of the segment gear, the lock arm, and the first follower link includes a second hard stop engaging the first of the segment gear, the lock arm, and the first follower link in the extended position.

6. The lock as in claim 3, wherein the first follower link supports a magnet, the frame includes a sensor opening, and further comprising a hall effect sensor having a sensor element disposed within the sensor opening and being operable to sense if the magnet is disposed above the sensor element.

7. The lock as in claim 6, wherein the magnet is disposed directly above the sensor element in the retracted position of the lock arm.

8. The lock as in claim 1, wherein the transmission includes a magnet, the frame includes a sensor opening, and further comprising a hall effect sensor having a sensor element disposed within the sensor opening and being operable to sense if the magnet is disposed above the sensor element.

9. The lock as in claim 1, wherein the drive unit includes an output gear having a plurality of gear teeth in driving engagement with the plurality of gear teeth of the segment gear.

10. The lock as in claim 1, wherein the frame includes a door being pivotable from a closed position to an open position and vice versa, in the open position the door being supported by the lock arm.

11. The lock as in claim 10, wherein the frame further includes at least a first extension spring biasing the door towards the closed position.

12. The lock as in claim 1, wherein the frame is mounted in a side wall of the slide-out room, and when retracted the arm is inside the side wall and when extended the arm extends outside the side wall of the slide-out room at an angle to the side wall of the slide-out room.

13. The lock as in claim 12, wherein the arm moves through an angle of 70 to 90 degrees between the extended and retracted positions.

14. A lock for a vehicle having a slide-out room being extendable relative to a side wall of the vehicle, the lock comprising:
a frame connected to the slide-out room;
a drive unit supported by the frame;
a transmission driven by the drive unit, the transmission including:
a segment gear pivotally supported by the frame, the segment gear having a peripheral edge including a plurality of gear teeth and a foot;
at least a first follower link having a first end pivotally connected to the segment gear and a second end opposite the first end;
a lock arm pivotally supported by the frame and pivotally connected to the second end of the first follower link so as to be driven by the drive unit through the transmission, the lock arm being driven so as to pivot from an extended position to a retracted position and vice versa, in the extended position the lock arm engaging the side wall of the vehicle to prevent the slide-out room from extending relative to the side wall of vehicle, and in the retracted position the lock arm disengaging the side wall of the vehicle and engaging the foot of the segment gear; and
a sensor unit being operable to determine if the lock arm is in the retracted position.

15. The lock as in claim 14, wherein the first follower link supports a magnet, and the sensor unit includes a sensor element being operable to sense if the magnet is disposed directly above the sensor element.

16. The lock as in claim 14, wherein the lock arm includes a leg engaging the segment gear in the extended position.

17. The lock as in claim 14, wherein the segment gear is pivotally supported by the frame at a first position and lock arm is pivotally supported by the frame at a second position spaced apart from the first position so that the segment gear, the lock arm, the first follower link, and the frame define a four-bar linkage mechanism.

18. The lock as in claim 14, wherein the frame includes a door being pivotable from a closed position to an open position and vice versa, in the open position the door being supported by the lock arm.

19. The lock as in claim 18, wherein the frame further includes an outer flange connected to the side wall of the slide-out room and having a front surface, the door being recessed from the front surface in the closed position.

20. The lock as in claim 19, wherein the frame further includes an extension spring biasing the door to the closed position.
